(19) United States
(12) Patent Application Publication
(10) Pub. No.: US 2007/0208510 A1
(43) Pub. Date: Sep. 6, 2007

(54) Method of identifying and localizing drainage tile problems

(75) Inventors: Noel Wayne Anderson, Fargo, ND (US); Stephen Michael Faivre, Kingston, IL (US); Mark William Stelford, Sycamore, IL (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/366,065

(22) Filed: Mar. 2, 2006

(51) Int. Cl. G01V 7/00

(52) U.S. Cl. 702/2; 405/36

(57) ABSTRACT

A method of identifying drainage tile problems in a field including steps of detecting, predicting and comparing moisture levels. The steps including detecting a moisture level at predetermined locations in the field; predicting moisture levels at the predetermined locations; and comparing the moisture levels detected in the detecting step with the moisture levels predicted in the predicting step.

### FIELD OF THE INVENTION

The present invention relates to identifying a type of drainage tile problem and localizing the problem.

### BACKGROUND OF THE INVENTION

Drainage tile are essential parts of a drainage system in a field. They convey excess water from low spots so that the field remains fairly uniformly dry to enable field operations. If a tile line has a problem, which restricts the flow of water, areas of the field upstream from the problem will drain more slowly than normal after a rain or snow melt. A delay in drainage causes a delay in field operations while the water leaves the low spot by other means. Another problem with ineffective drainage is that damaged or dead crops may result from the roots being submerged in water for an excessive period of time, cutting off the normal flow of atmospheric gases to the roots.

Tile repair typically involves digging up the damaged section of the tile line, cleaning or replacing it, and then filling in the hole. If the problem spot cannot be precisely localized, a trial and error approach is often used in a suspected area of the problem. This approach can greatly increase the cost and time needed to effect the repair.

Boroscopes, with cameras can be pushed up a tile line to look for the problem, but this is typically only done after a problem has been identified. Further, this approach is expensive and requires expensive equipment and operational time.

What is needed in the art is a method and apparatus that will provide early and precise localization of drainage tile problems that minimize cost and impact on crops.

### SUMMARY OF THE INVENTION

The invention comprises, in one form thereof, a method for identifying drainage tile problems in a field. The method includes the steps of detecting moisture levels at predetermined locations in the field, predicting moisture levels at the predetermined locations, and comparing the moisture levels detected in the detecting step with moisture levels predicted in the predicting step.

### BRIEF DESCRIPTION OF THE DRAWINGS

FIG. 1 illustrates a farm field having many field nodes;

FIG. 2 illustrates a drainage tile pattern in the field of FIG. 1;

FIG. 3 illustrates localized field attributes in the field of FIGS. 1 and 2; and

FIG. 4 is a flowchart, illustrating an embodiment of a method for identifying and localizing drainage tile problems of the present invention.

### DESCRIPTION OF THE PREFERRED EMBODIMENT

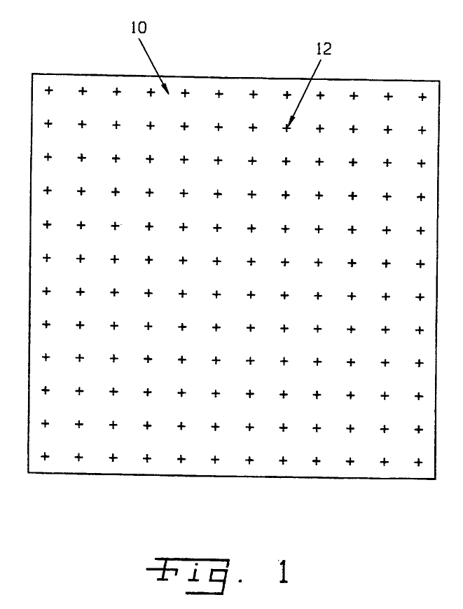

Referring now to the drawings, and more particularly to FIG. 1, there is shown a parcel of land or field 10, suitable for agricultural use, and may be under agricultural cultivation or lying in a fallow state. Field 10 may be subjected to crop harvesting operations such as mechanized mowing, combining, plowing, planting as well as human hand picking and animal foraging. Numerous field nodes 12 are dispersed through field 10 and divide the parcel into several sample areas. While nodes 12 are illustrated as being uniformly positioned throughout field 10, it can be understood that the positioning of field nodes 12 may be otherwise arranged.

Nodes 12 may be in the form of sensors 12 that provide information about localized attributes of field 10. Sensor 12 is communicatively linked to a data gathering center, not shown, which may include a computerized recording and processing capability. Sensors 12 provide information such as soil temperature, moisture level, and vertical information relative to these attributes at various depths of soil at node 12. Additionally, field nodes 12 may represent points of reference rather than sensor locations per say. For example, field nodes 12 may represent spatially defined positions that result from visual, penetrating radar, non-visual light observations, interaction of projected lasers upon positions represented by field nodes 12, etc. Data received relative to field nodes 12, whether from a sensor located at field node 12 or by way of an observed phenomenon at or about each field node 12 is gathered to provide information relative to soil conditions at field nodes 12.

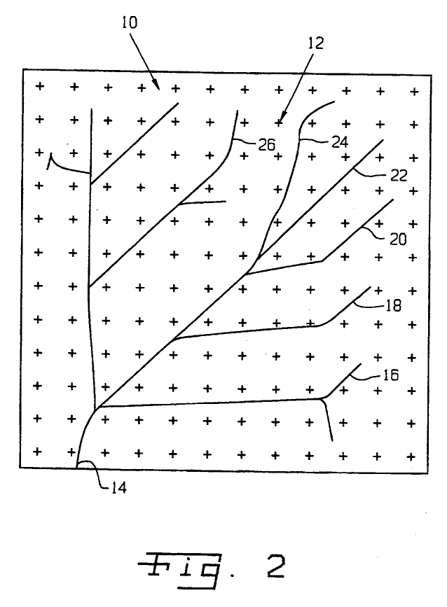

Now, additionally referring to Fig.2 there is shown a drainage tile network located in field 10 including a tile outlet 14 and representative tile branches 16, 18, 20, 22, 24 and 26. The drainage tile network is generally laid out so that water seeps into the tile network and flows along the various branches ultimately reaching tile outlet 14. The layout of the tile network is such that it is normally considered a gravitationally flowed system regardless of the topology of the land thereby typically requiring surveying and elevational knowledge by the installer for the tile system to operate correctly. Tile branches 16-26, as well as the rest of the tile system network are positioned across field 10 with many portions being proximate to various nodes 12.

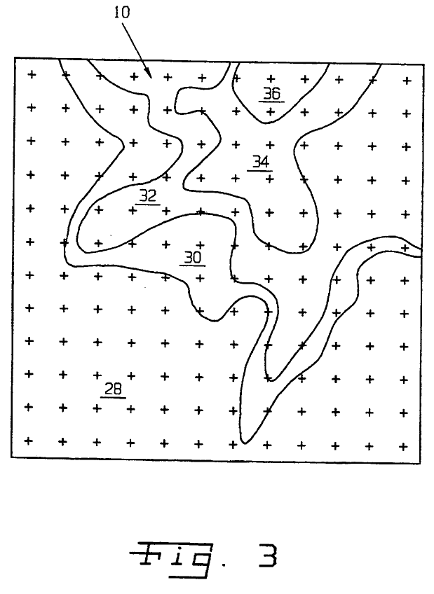

Now additionally referring to FIG. 3, field 10 may have soil with varying soil attributes 28, 30, 32, 34 and 36 which may relate to elevation, composition of the soil and moisture retention of the soil, etc. Soil attributes 28-36 illustrate that the present invention can operate with various soil attributes and provides interpretive procedures relative to the different soil attributes.

An aspect of modeling the moisture removal in field 10 includes understanding that water may leave field 10 in at least six manners. Once water enters field 10 by way of irrigation, water running onto field 10, or most commonly by rain activity or snow melt, moisture is removed in some manner. Various manners in which water will leave field 10 include evaporation into the atmosphere, surface runoff, soil absorption, absorbed by plants in field 10, drainage by way of the tile network through tile outlet 14, or by subsoil absorption into the water table and/or aquifer. Evaporation into the atmosphere, may be modeled using an evapotranspiration modeling technique, which predicts the atmospheric evaporation based on such things as temperature, insolation, and humidity. Water runoff is often the function of the geography of field 10 as well as the amount of moisture capacity of the soil and the amount of water that comes into field 10 by any of the manners in which it could enter a field. The moisture content of the soil, the ability of the soil to absorb moisture, and the transmission of water from an underground source, such as a spring are other aspects of the movement of water into the tile network system of field 10. The presence or absence of plants as well as the maturity of plants that are present in field 10 effect the amount of water that is absorbed thereby and utilized by the plants in their growing process. The tile system in field 10 allows for moisture to absorb through the subsoil by way of slots or holes in tile so that water entering tile branch 22 will flow along branch 22 and then merge with other branches ultimately reaching tile outlet 14. The subsoil absorption of moisture as well as surface fun off also effect the movement of water in field 10. Soil attributes can vary throughout field 10 as shown in FIG. 3. For example, soil attributes 36 may include a highly clay ground which may poorly conduct water to tile branch 24. Conversely soil attributes 32 may be of a sandy type soil allowing a quick conduction of moisture from this type of soil to the various branches of tile that pass therethrough.

A variety of in situ sensor technologies are available based upon U.S. Pat. Nos. 3,882,383; 5,424,649; and 5,430,384, which include soil moisture sensors that can be deployed to collect data with good spatial and temporal resolution. Data between the sensors can be interpolated using methods, such as inverse fourth power and other geostatistical methods. With this understanding, nodes 12 may be a data point for which a soil moisture sensor 12 is positioned or node 12 may be a data point that has been created in a interpolation method from information at other sensor points.

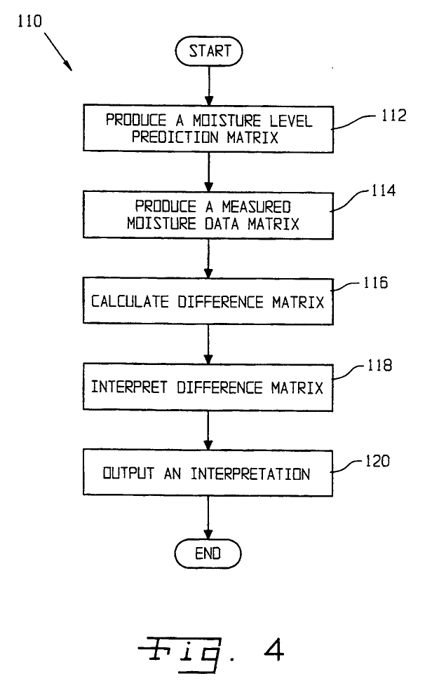

Now, additionally referring to FIG. 4 there is shown a flow chart of an embodiment of a method 110 of the present invention, including the step of providing a moisture level prediction matrix at step 112, which includes a prediction of what a moisture level should be at each node 12 in field 10 based on the occurrence of moisture inputs into field 10. For example, if a one inch rain has fallen upon field 10 over the past three hour period, this level of input is utilized to create the moisture level prediction matrix as to what the moisture level should be at each node 12 at various times following the one inch rain event. A second matrix is produced at step 114 which is a measured moisture data matrix that relates to measured moisture levels at each of field nodes 12. The moisture level prediction matrix and the measured moisture data matrix are mathematically compared, for example, by way of calculating a difference matrix at step 116. This can simply be an element by element subtraction of the first matrix from the second matrix to result in the difference matrix that is then subsequently evaluated. Large positive element values may indicate locations with significantly more measured moisture than predicted by the prediction methods of the present invention.

At step 118 interpretation of the difference matrix is undertaken. This may be done by a skilled observer or by software utilizing techniques such as pattern recognition, neural networks and/or fuzzy logic. Additionally, a combination of human and automated techniques may be utilized to interpret the difference matrix. The interpretational techniques also can utilize additional information such as digital elevation maps showing water flow, a 3-D soil map, which may include information about soil attributes 28 through 36, a tile map such as that illustrated in FIG. 2, and information relative to field machinery traffic. Since soil attributes in field 10 may include variations in elevation, the tile depth relative to the elevation is also a factor to predict the amount of water flow in the tile branches.

Some interpretive results include the detecting of high moisture readings as illustrated by an interpretation of the difference matrix showing a sharp rise along a tile branch as the data is analyzed moving up the line along the tile route. If the readings are not high along neighboring parallel tile lines, for example branch lines 20 and 22, then a blockage likely exists at the intersection of the rise in moisture levels and the tile branch. More specifically, if tile branch 22 has a relatively higher moisture reading therealong than tile branch 20, it could be concluded that there is a blockage in tile branch 22 that is either slowing the exit of water therefrom or it may be completely blocked not allowing any water to flow through tile branch 22. The information at field nodes 12 proximate to tile branch 22 can be interpolated to provide a position that is estimated based on the values at nodes 12, thereby localizing the area in which the blockage exists.

Another interpretive method relates to a very localized rise in measured soil moisture, which does not extend up-line along the nearest tile lines then this reading may be a faulty sensor or inaccurate sensor reading.

Yet another interpretation is if there is a substantially high difference between the predicted and measured moisture across the entire field, then the problem may exist at tile outlet 14. If tile outlet 14 is not actually an outlet to a surface location but rather continues on then it may also be concluded that the obstruction or blockage is downstream from tile outlet 14.

Yet another interpretation which may result from executing step 118 is that if a uniformly high moisture level is measured near the soil surface versus a deeper level, such as close to the tile line depth and that there has been major field work since the last major rain or irrigation event, then the field work may have created a compacted layer, such as a clay pan, that is impeding the water flow from the upper layers of soil past the compaction level to the tile in subsoil levels. This may indicate the need for tillage to take place to an appropriate depth to break up the compaction layer. As can be seen the interpretive results can determine blockage levels in the tile lines, soil conditions and sensor problems.

The information interpreted in step 118 is output at step 120 to a user if the information at step 118 is the result of a computing algorithm contained in a computing machine. The output may include information relative to recent water inputs into field 10 along with information about potential localized blockages in the drainage tile system. Computer graphics and other output techniques may be utilized. The information may include coordinates for the predicted problem, which can be used with a GPS system or interaction with sensors 12 to find the problem area.

Method 110 can be additionally utilized if the information received about field nodes 12 is developed in another manner. For example, relative surface soil moistures can be measured visually. This is most practical in the spring before crops emerge and the tile lines are especially visible using infrared and other lightwave techniques. The surface images are collected using ground vehicle mounted cameras, aerial cameras and/or satellite borne cameras. The visual information is utilized to generate a calibrated individual or plurality of ground maps over periods of time, where intensity of changes of reflected light correspond to soil moisture changes. For example, an abnormal darkness in one area of field 10 may indicate a higher moisture level. The soil model generates a matrix of information relative to field nodes 12, where each element corresponds to an expected soil surface color based on soil type, soil color being reflective of a of moisture level that relates to that soil color. This may vary across field 10 and soil attributes 28 through 36 are considered in the model so that one reflected color in one section such as soil attributes 28 may vary from soil attributes 30 and are thereby compensated for in the interpretive method of the present invention. This is done by utilizing the known difference of colors that equate to different moisture levels. The camera data is then utilized to generate the second matrix where elements have measured soil moistures for the corresponding field nodes 12 in the field 10. The first matrix and the second matrix are then mathematically compared, for instance creating a difference matrix as in step 116 to compare the expected colors of soil versus the measured colors of soil. It should be noted that other methods of projecting light and/or radar waves upon field 10 can also be utilized to generate matrix data that is similarly interpreted.

A time sequence of matrices can be utilized to record the expected drying sequence. For example, historical information based on a series of sequential matrices can be utilized to predict expected outcomes from similar rainfall and/or irrigation events. The predictive method of the present invention compensates for the speed of drying that may be due to evapotransporation factors to more accurately predict the flow of water through the drainage tile system. This is helpful in situations where the problem is a partial obstruction rather than a blockage. The time sequential series predicts a trending for the moisture removal from field 10 and if a certain section of field 10, such as along tile branch 26 does not dry at the predicted speed of drying then it can be inferred that there may be a partial obstruction, which can then be addressed if the field is not planted or may be delayed until after a crop is harvested so that maintenance can be done with minimal damage to the crop. This advantageously allows for a more sensitive prediction of problems before a full blockage occurs.

Having described the preferred embodiment, it will become apparent that various modifications can be made without departing from the scope of the invention as defined in the accompanying claims.

### ASSIGNMENT

The entire right, title and interest in and to this application and all subject matter disclosed and/or claimed therein, including any and all divisions, continuations, reissues, etc., thereof are, effective as of the date of execution of this application, assigned, transferred, sold and set over by the applicant(s) named herein to Deere & Company, a Delaware corporation having offices at Moline, Ill. 61265, U.S.A., together with all rights to file, and to claim priorities in connection with, corresponding patent applications in any and all foreign countries in the name of Deere & Company or otherwise.

1. A method of identifying drainage tile problems in a field, comprising the steps of:
detecting moisture levels at predetermined locations in the field;
predicting moisture levels at said predetermined locations; and
comparing said moisture levels detected in said detecting step with said moisture levels predicted in said predicting step.

2. The method of claim 1, further comprising the step of interpreting information from said comparing step to identify the problem with the drainage tile.

3. The method of claim 2, further comprising the step of assigning the problem to a locality of the drainage tile.

4. The method of claim 1, wherein said detecting step is carried out by a transfer of information from moisture sensors located at each of said predetermined locations.

5. The method of claim 1, wherein said moisture levels detected in said detecting step are arranged in a first matrix and said moisture levels predicted in said predicting step are arranged in a corresponding second matrix.

6. The method of claim 5, wherein said comparing step is a differencing step in which said first matrix and said second matrix are differenced.

7. The method of claim 5, wherein said first matrix is associated with a date and time and is saved as one of a plurality of saved first matrices.

8. The method of claim 7, wherein said predicting step uses information in said plurality of saved first matrices to predict moisture levels.

9. The method of claim 1, wherein said comparing step uses information obtained proximate to neighboring drainage tiles to detect the location of the problem.

10. The method of claim 1, wherein said comparing step uses information obtained along a drainage tile branch to detect the location of the problem.

11. The method of claim 1, wherein said comparing step determines that the problem is downstream of an outlet tile if a significant number of said moisture levels detected in said detecting step are higher than said moisture levels predicted in said predicting step.

12. The method of claim 1, wherein said comparing step determines that the problem is due to soil compaction if said moisture levels are uniformly high near the soil surface as compared to moisture levels at deeper levels.

13. The method of claim 1, wherein said detecting step uses information from at least one of absorbed light and reflected light to establish said moisture levels at said predetermined locations.

14. The method of claim 1, wherein said detecting step is repeated over predetermined time periods to produce a time sequence of data.

15. The method of claim 14, wherein said time sequence of data is used in said prediction step to predict a speed of drying of the field.

16. The method of claim 15, further comprising the step of compensating said speed of drying with evapotranspiration factors.

17. The method of claim 1, wherein the problem is one of a blockage and a partial obstruction of the drainage tile.

18. A method of identifying drainage tile problems in a field, comprising the steps of:
measuring moisture levels at a predetermined time at a geographical location in the field;
calculating moisture levels for said geographical location for said predetermined time; and
comparing said moisture levels measured in said measuring step with said moisture levels calculated in said calculating step.

19. The method of claim 18, further comprising the step of interpreting information from said comparing step to identify the problem with the drainage tile.

20. The method of claim 19, further comprising the step of assigning the problem to a particular locality of the drainage tile in the field.

21. The method of claim 18, wherein said moisture levels measured in said measuring step are arranged in a first matrix and said moisture levels calculated in said calculating step are arranged in a corresponding second matrix.

22. The method of claim 21, wherein said comparing step is a differencing step in which said first matrix and said second matrix are differenced.
